(19) United States
(12) Patent Application Publication
(10) Pub. No.: US 2010/0181519 A1
(43) Pub. Date: Jul. 22, 2010

(54) AUTOMATIC SWITCH VALVE

(76) Inventors: Renzhong LI, Xiamen (CN); Hao Deng, Xiamen (CN)

Correspondence Address: Dr. BANGER SHIA;Patent Office of Bang Shia, 102 Lindencrest Ct., Sugar Land, TX, 77479-5201, US

(21) Appl. No.: 12/358,169

(22) Filed: Jan. 22, 2009

(51) Int. Cl. F16K 1/00

(52) U.S. Cl. 251/325

(57) ABSTRACT

An automatic valve includes a three-way valve body and a valve core disposed in the valve body. The valve core has a large flange and a small flange formed at middle and front sections, an axial hole therein, and a water outlet formed between the large and small flanges. The water outlet interconnects with the axial hole. The valve body has a front section connected with a connector. A retaining head is inserted into the connector to connect with the valve core. The small flange of the valve core is moved to seal the connector. The water flows into the axial hole, out from the water outlet of the valve core, and into the chambers of the valve body. The valve body may use one side port to connect with a feed pipe and the other side port and the lower port as outlets to connect with outlet devices.

### BACKGROUND OF THE INVENTION

1. Field of the Invention

The present invention relates to a water passage switch, and more particularly to an automatic switch valve.

2. Description of the Prior Art

A switch valve is used in a switch device of a bath system. A shower sprinkle-nozzle adapted to domestic use or used in an inn is coupled with a fixed shower head or a movable spray nozzle for a desired shower bath. A switch valve is used to control the water to flower out from the shower head or the spray nozzle.

As shown in FIGS. 1, and 2, a conventional switch valve comprises a valve body 1′ and a valve core 2′. The valve body 1′ has two outlets 11′ and 12′ at two ends for connecting with a shower head tube and a spray nozzle tube, respectively. The valve body 1′ has a chamber 13′ which is a stepped hole, and an inlet 14′ interconnecting with the chamber 13′ at a middle portion thereof. The valve core 2′ is formed with a large flange 21′ and a small flange 22′ disposed in the chamber 13′ and located at two sides of the inlet 14′ respectively. Referring to FIG. 1, when the outlet 11′ at one side of the large flange 21′ is connected to a water outlet device and is in an open state, the valve core 2′ will be urged by the liquid pressure to move toward the outlet 11′ so that the large flange 21′ is moved to a position which is not sealed. The outlet 11′ is interconnected with the inlet 14′, while the small flange 22′ is to block the outlet 12′ at the other end. Referring to FIG. 2, when the outlet 11′ at one side of the large flange 21′ is in a closed state, the valve core 2′ will be urged by the liquid pressure to move toward the outlet 12′ so that the small flange 21′ is moved to a position which is not sealed. The outlet 12′ is interconnected with the inlet 14′, while the large flange 21′ is to block the stepped hole so that the inlet 11′ is in a closed state, achieving the function of an automatic switch valve. In general, the outlet 11′ at one side of the large flange 21′ is connected with the spray nozzle and the outlet 12′ at the other end is connected with the shower head. Because the switch to operate the movable spray nozzle is more convenient, controlling the water to flow out through the two outlet devices relies on the switch provided on the spray nozzle.

The inlet 14′ of the conventional automatic switch valve is disposed at the middle portion of the valve body 1′, but an outlet pipe of a water supply system is disposed on a wall. Accordingly, when the automatic switch valve is coupled with the outlet pipe, the two outlets 11′ and 12′ will face upward and downward, respectively. Hence, it is necessary for the outlet 12′ facing upward to be coupled with a curved pipe so as to connect with the shower head. This needs more mounting space for the automatic switch valve. In addition, the length of the valve body 1′ has to match to the moving space of the two flanges 21′ and 22′, which is larger in size.

### SUMMARY OF THE INVENTION

The primary objective of the present invention is to provide an automatic switch valve to be integrated with a piping, occupying less space.

According to the present invention, there is provided an automatic switch valve, comprising a three-way valve body and a valve core disposed in the valve body, the valve core having a large flange and a small flange formed at middle and front sections thereof, the valve core being a tube having an axial hole and a water outlet formed between the large flange and the small flange, the water outlet interconnecting with the axial hole, the valve body having a front section connected with a connector, a retaining head inserting into the connector to connect with the valve core, the small flange of the valve core being moved to seal the connector.

Preferably, the valve body includes a lateral inner chamber therein, a collar disposed at a central portion of the inner chamber, a through hole formed in front of the collar, and a vertical inner chamber interconnecting with the through hole, the collar having a central hole for insertion of the valve core.

Preferably, the lateral inner chamber of the valve body is formed with inner threads at front and rear sections thereof.

Preferably, the connector is formed with a protrusion extending from an outer edge of a central portion thereof, the protrusion being to restrict the depth of the connector screwed into the valve body, the connector having a reduced hole at a central section and enlarged holes at front and rear sections.

Preferably, the connector is formed with outer threads at the front and rear sections.

Preferably, the valve core has an outer diameter smaller than or equal to inner diameters of the central hole of the collar and the reduced hole of the connector, and the large flange of the valve core has an outer diameter smaller than or equal to an inner diameter of the enlarged hole at the rear section of the connector and larger than the inner diameter of the reduced hole at the central section of the connector.

Preferably, the valve core is formed with at least one water outlet.

Preferably, the retaining head is a T-shaped threaded head having inner threads at a rear section thereof, corresponding to the axial hole of the valve core, and an end head at a front section thereof, the end head having an outer diameter smaller than or equal to the inner diameter of the reduced hole of the connector.

Preferably, the retaining head is connected with the valve core to form a sealed connection with the reduced hole of the connector.

The automatic switch valve of the present invention includes the valve core disposed in the three-way valve body. The valve core has the axial hole therein. The water flows into the axial hole, out from the water outlet of the valve core, and into the chambers of the valve body. The valve body may use one side port to connect with a feed pipe. The other side port and the lower port of the valve body function as outlets to connect with outlet devices. The large flange and the small flange are disposed at the front and rear of the water outlet. The water from the water outlet to the chambers of the valve body produces pressure with respect to the two flanges and so that the valve core is moved forward or rearward to control the water to flow out through either of the two outlets, providing a switch valve function. The valve core uses the connector and the retaining head for fixing. The connector is externally connected with a piping. Therefore, the automatic switch valve and the piping are integrated, reducing the mounting space effectively.

### BRIEF DESCRIPTION OF THE DRAWINGS

FIG. 1 is a first cross-sectional view of a conventional switch valve;

FIG. 2 is a second cross-sectional view of the conventional switch valve;

FIG. 3 is a schematic view of the present invention;

FIG. 4 is a cross-sectional view of the present invention;

FIG. 5 is a perspective view of a valve core of the present invention;

FIG. 6 is a schematic view of the present invention showing the water to flow in;

FIG. 7 is a schematic view of the present invention showing the water to flow out through a spray nozzle; and

FIG. 8 is a schematic view of the present invention showing the water to flow out through a shower head;

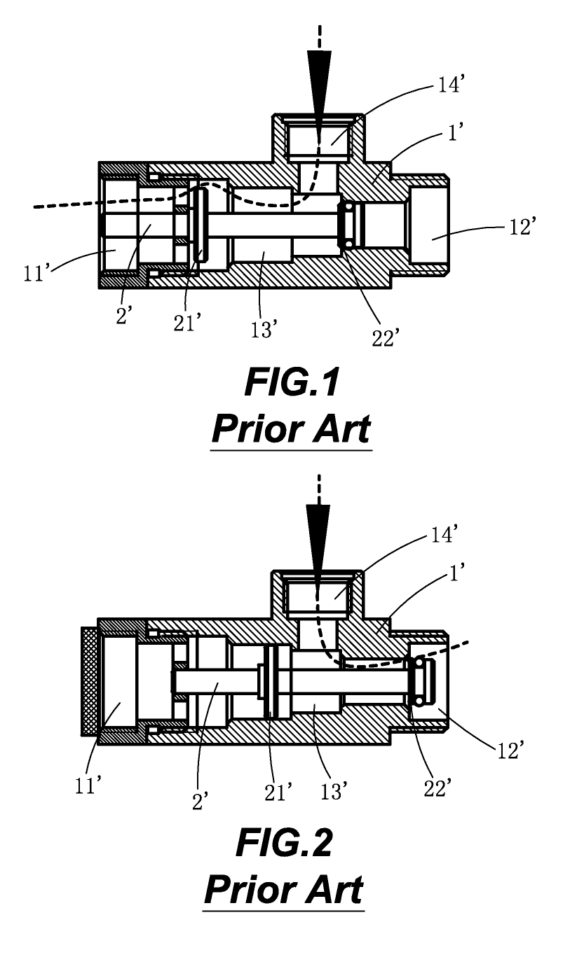

### DETAILED DESCRIPTION OF THE PREFERRED EMBODIMENTS

Embodiments of the present invention will now be described, by way of example only, with reference to the accompanying drawings.

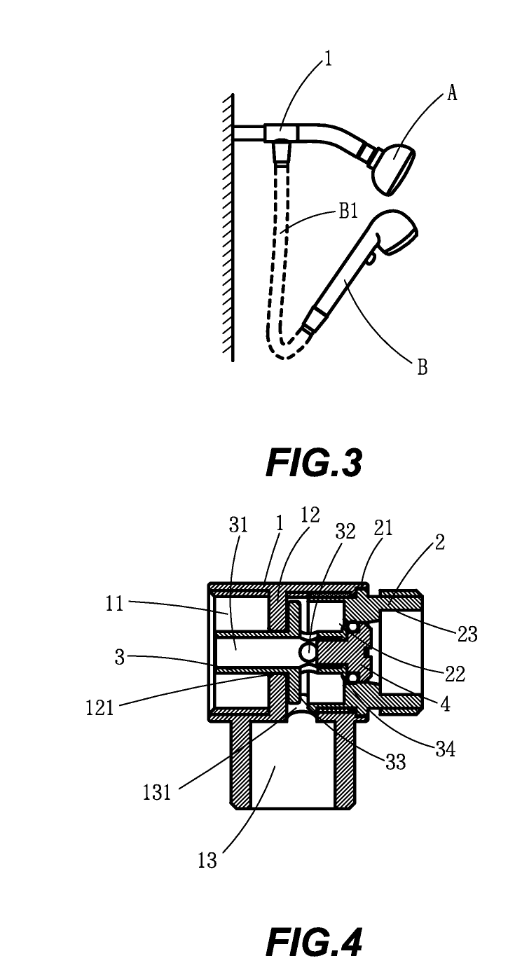

As shown in FIGS. 3 and 4, a switch valve of the present invention comprises a valve body 1, a connector 2, a valve core 3, and a retaining head 4.

The valve body 1 is a three-way tube, and has a lateral inner chamber 11 therein, a collar 12 disposed at a central portion of the inner chamber 11, a through hole 131 formed in front of the collar 12, and a vertical inner chamber 13 interconnecting with the through hole 131. The collar 12 has a central hole 121. The lateral inner chamber 11 of the valve body 1 is formed with inner threads at front and rear sections thereof.

The connector 2 is formed with outer threads at front and rear sections thereof and a protrusion 21 extending from an outer edge of a central portion thereof. The protrusion 21 is to restrict the depth of the connector 2 screwed into the valve body 1. The connector 2 has a reduced hole 22 at a central section and enlarged holes 23 at front and rear sections. With the outer threads at front and rear sections of the connector 2, one end of the connector 2 is screwed into the valve body 1 and the other end of the connector 2 is connected to an external piping.

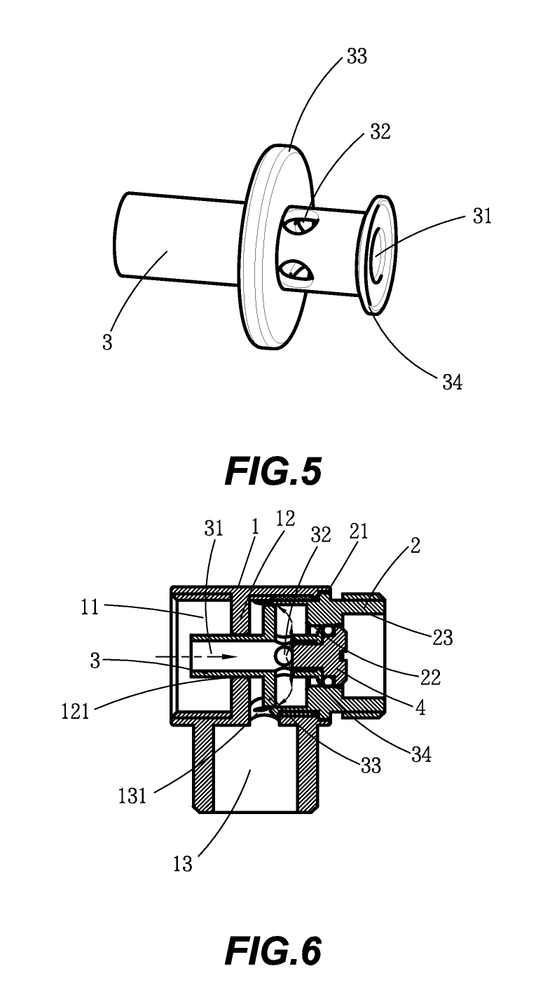

Referring to FIG. 5, the valve core 3 is a tube having an axial hole 31. The outer diameter of the valve core 3 is smaller than or equal to the inner diameters of the central hole 121 of the collar 12 and the reduced hole 22 of the connector 2. The valve core 3 has a large flange 33 extending from a central portion thereof. The outer diameter of the large flange 33 is smaller than or equal to the inner diameter of the enlarged hole 23 at the rear section of the connector 2 and larger than the inner diameter of the reduced hole 22 at the central section of the connector 2. The valve core 3 is formed with at least one water outlet 32 disposed in front of the large flange 33. The water outlet 32 interconnects with the axial hole 31. The valve core 3 is formed with inner threads at a front section thereof and a small flange 34 at a front end thereof.

The retaining head 4 is a T-shaped threaded head, which has inner threads, corresponding to the axial hole 31 of the valve core 3, at a rear section thereof and an end head at a front section thereof. The outer diameter of the end head is smaller than or equal to the inner diameter of the reduced hole 22 of the connector 2.

Referring to FIG. 4, the valve core 3 is inserted into the lateral chamber 11 from the front of the valve body 1, with the rear section of the valve core 3 extending into the central hole 121 of the collar 12. The rear section of the connector 2 is screwed to the front section of the lateral chamber 11. The retaining head 4 is screwed to the front section of the valve core 3 from the through hole of the connector 2. A sealed space is defined between the end head of the retaining head 4 and the small flange 34 at the front end of the valve core 3. The front end of the valve core 3 is inserted into the sealed spaced to hold against the retaining head 4, which forms a sealed connection with the reduced hole 22 of the connector 2. As shown in FIG. 4, when the large flange 33 of the valve core 3 holds against the front of the collar 12, the retaining head 4 will be located in the reduced hole 22 of the connector 2 to form an automatic switch valve.

FIG. 3 shows the automatic switch valve of the present invention used in a bathroom. The rear of the lateral inner chamber 11 of the valve body 1 is connected to a feed pipe. The front of the lateral chamber 11 is connected to a shower head A with the connector 2. The lower section of the vertical inner chamber 13 is connected with a hose B1 of a spray nozzle B. By the connection of the front end of the valve body 1 and the connector 2, the automatic switch is integrated with a piping to reduce the mounting space effectively.

In practice, when a water source switch is opened, the automatic switch valve is operated to control the water to flow out through either of the shower head B and the spray nozzle A. When the water flows out through the shower head B, the spray nozzle A will be in a closed state. When the water flows out through the spray nozzle B, the shower head A will be in a closed state.

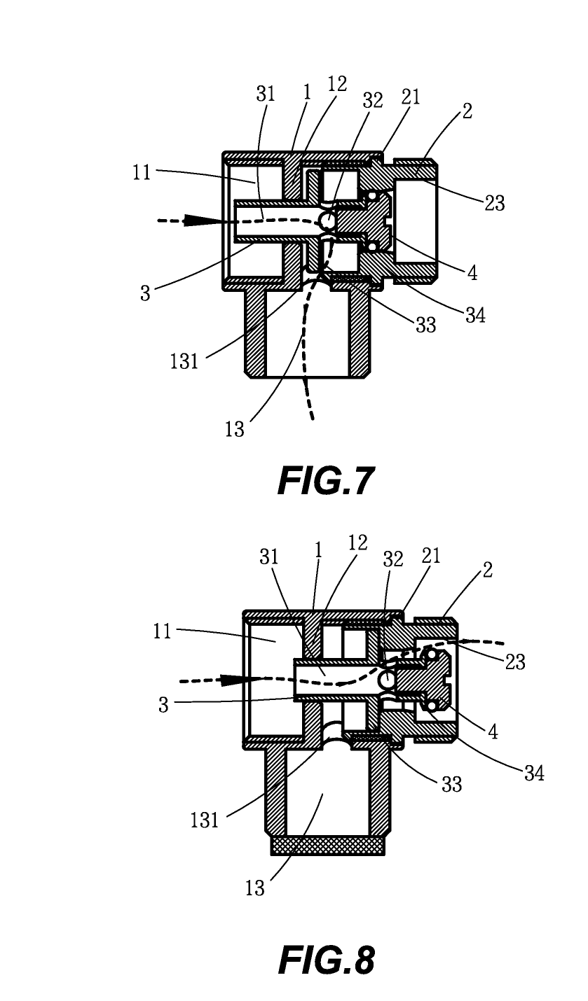

As shown in FIG. 6, the water flows into the axial hole 31 of the valve core 3, out from the water outlet 32 and into the space between the front portion of the valve body 1 and the connector 2. The large flange 33 and the small flange 32 of the valve core 3 are urged by the liquid pressure. Because the large flange 33 is larger than the small flange 34, the valve core 3 is moved rearwards with respect to the valve body 1, referring to FIG. 7. The retaining head 4 and the reduced hole 22 of the connector 2 are sealed. Accordingly, the shower head A is in a closed state. The water flows out through the spray nozzle B from the vertical inner chamber 13.

As shown in FIG. 8, the spray nozzle B is in a closed state. The vertical inner chamber 13 is closed. Because there is no water in the lower area, the pressures at both sides of the large flange 33 are counterbalanced. The large flange 33 is urged to move forwards such that the valve core 3 is moved forwards. When the front surface of the large flange 33 holds against the rear end of the reduced hole 22 of the connector 2, the water outlet 32 of the valve core 3 will be located in the reduced hole 22, while the small flange 34 and the retaining head 4 will extend outside the reduced hole 22. The connector 2 is in an open state. The water flows out through the shower head A.

To sum up, the automatic switch valve of the present invention includes the valve core 3 disposed in the three-way valve body 1. The valve core 3 has the axial hole 31. The water flows into the axial hole 31, out from the water outlet 32 of the valve core 3, and into the chambers of the valve body 1. The valve body 1 may use one side port to connect with a feed pipe. The other side port and the lower port of the valve body 1 function as outlets to connect with outlet devices. The large flange 33 and the small flange 34 are disposed at the front and rear of the water outlet 32. The water from the water outlet 32 to the chambers of the valve body 1 produces pressure with respect to the two flanges 33 and 34 so that the valve core 3 is moved forward or rearward to control the water to flow out through either of the two outlets, providing a switch valve function. The valve core 3 uses the connector 2 and the retaining head 4 for fixing. The connector 2 is externally connected with a piping. Therefore, the automatic switch valve and the piping are integrated, reducing the mounting space effectively.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. An automatic switch valve, comprising a three-way valve body and a valve core disposed in the valve body, the valve core having a large flange and a small flange formed at middle and front sections thereof, the valve core being a tube having an axial hole and a water outlet formed between the large flange and the small flange, the water outlet interconnecting with the axial hole, the valve body having a front section connected with a connector, a retaining head inserting into the connector to connect with the valve core, the small flange of the valve core being moved to seal the connector.

2. The automatic switch valve as claimed in claim 1, wherein the valve body includes a lateral inner chamber therein, a collar disposed at a central portion of the inner chamber, a through hole formed in front of the collar, and a vertical inner chamber interconnecting with the through hole, the collar having a central hole for insertion of the valve core.

3. The automatic switch valve as claimed in claim 2, wherein the lateral inner chamber of the valve body is formed with inner threads at front and rear sections thereof.

4. The automatic switch valve as claimed in claim 1, wherein the connector is formed with a protrusion extending from an outer edge of a central portion thereof, the protrusion being to restrict the depth of the connector screwed into the valve body, the connector having a reduced hole at a central section and enlarged holes at front and rear sections.

5. The automatic switch valve as claimed in claim 4, wherein the connector is formed with outer threads at the front and rear sections.

6. The automatic switch valve as claimed in claim 1, wherein the valve core has an outer diameter smaller than or equal to inner diameters of the central hole of the collar and the reduced hole of the connector, and the large flange of the valve core has an outer diameter smaller than or equal to an inner diameter of the enlarged hole at the rear section of the connector and larger than the inner diameter of the reduced hole at the central section of the connector.

7. The automatic switch valve as claimed in claim 2, wherein the valve core has an outer diameter smaller than or equal to inner diameters of the central hole of the collar and the reduced hole of the connector, and the large flange of the valve core has an outer diameter smaller than or equal to an inner diameter of the enlarged hole at the rear section of the connector and larger than the inner diameter of the reduced hole at the central section of the connector.

8. The automatic switch valve as claimed in claim 4, wherein the valve core has an outer diameter smaller than or equal to inner diameters of the central hole of the collar and the reduced hole of the connector, and the large flange of the valve core has an outer diameter smaller than or equal to an inner diameter of the enlarged hole at the rear section of the connector and larger than the inner diameter of the reduced hole at the central section of the connector.

9. The automatic switch valve as claimed in claim 1, wherein the valve core is formed with at least one water outlet.

10. The automatic switch valve as claimed in claim 1, wherein the retaining head is a T-shaped threaded head having inner threads at a rear section thereof, corresponding to the axial hole of the valve core, and an end head at a front section thereof, the end head having an outer diameter smaller than or equal to the inner diameter of the reduced hole of the connector.

11. The automatic switch valve as claimed in claim 4, wherein the retaining head is a T-shaped threaded head having inner threads at a rear section thereof, corresponding to the axial hole of the valve core, and an end head at a front section thereof, the end head having an outer diameter smaller than or equal to the inner diameter of the reduced hole of the connector.

12. The automatic switch valve as claimed in claim 1, wherein the retaining head is connected with the valve core to form a sealed connection with the reduced hole of the connector.

13. The automatic switch valve as claimed in claim 4, wherein the retaining head is connected with the valve core to form a sealed connection with the reduced hole of the connector.
